(19) United States
(12) Patent Application Publication
(10) Pub. No.: US 2007/0034563 A1
(43) Pub. Date: Feb. 15, 2007

(54) Connection device for inlet and outlet of water purifying device

(76) Inventor: Ming-Yen Wu, Chang-Hua (TW)

Correspondence Address: MING-YEN WU, P.O. BOX 487, CHANG-HUA CITY 500, TW

(21) Appl. No.: 11/199,848

(22) Filed: Aug. 10, 2005

(51) Int. Cl. B01D 35/00

(52) U.S. Cl. 210/435; 210/449; 285/18; 285/417

(57) ABSTRACT

A water purifying device includes a body with purifying material received therein and the body includes an inlet and an outlet. A first connection device and a second connection device are respectively connected to the inlet and the outlet so as to connect with different parts. The first connection device includes a box with a hole defined therethrough and a slot is defined in a side of the box so that a clamp with two clamp portions is movably inserted into the slot. The two clamp portions each include two recesses so as to form two circular holes defined between the two clamp portions and hoses or connectors of different sizes can be engaged with the circular holes. The second connection device can be a threaded part for threadedly connecting with another part.

### FIELD OF THE INVENTION

The present invention relates to a water purifying device which includes two connection devices on the inlet and outlet so as to be connected with different types of hoses or parts.

### BACKGROUND OF THE INVENTION

A conventional water purifying device generally includes a body with an inlet and an outlet so as to introduce water in the water purifying device and the purified water can be obtained from the outlet. The body includes two connection devices located at the inlet and the outlet so as to be connected with a hose or a faucet. Most of the conventional connection devices are threads defined in an outside or inside of the inlet and the outlet, and the hose or faucet to be connected with the connection devices has to be equipped with complimentary threads so as to be connected to the body. However, there are so many different ways of connection for the hoses or the faucets in the market and which cannot be used to cooperate with the threads of the conventional connection devices.

The present invention intends to provide a water purifying device that includes different types of connection devices so as to be connected with hoses or faucets in the existed market.

### SUMMARY OF THE INVENTION

The present invention relates to a water purifying device which comprises a body having an inlet and an outlet, and purifying material is received in the body. A first connection device and a second connection device are respectively connected to the inlet and the outlet so as to be respectively connected with different parts.

The primary object of the present invention is to provide a water purifying device with connection devices on the inlet and the outlet, the connection devices are conveniently connected with different types of hoses or faucets.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a first embodiment of the water purifying device of the present invention;

FIG. 2 is a perspective view to show the first embodiment of the water purifying device of the present invention;

FIG. 3 is a cross sectional view of the first embodiment of the water purifying device of the present invention;

FIG. 4 shows a second embodiment of the water purifying device of the present invention;

FIG. 5 is a cross sectional view of the water purifying device in FIG. 4;

FIG. 6 is a cross sectional view of the third embodiment of the water purifying device;

FIG. 7 is a cross sectional view of the forth embodiment of the water purifying device;

FIG. 8 is a cross sectional view of the fifth embodiment of the water purifying device;

FIG. 9 is a cross sectional view of the sixth embodiment of the water purifying device;

FIG. 10 is a cross sectional view of the seventh embodiment of the water purifying device;

FIG. 11 is a cross sectional view to show that the connection member in FIG. 10 is connected to the locking member of the seventh embodiment of the water purifying device, and

FIG. 12 is a cross sectional view of the eighth embodiment of the water purifying device.

### DETAILED DESCRIPTION OF THE PREFERRED EMBODIMENT

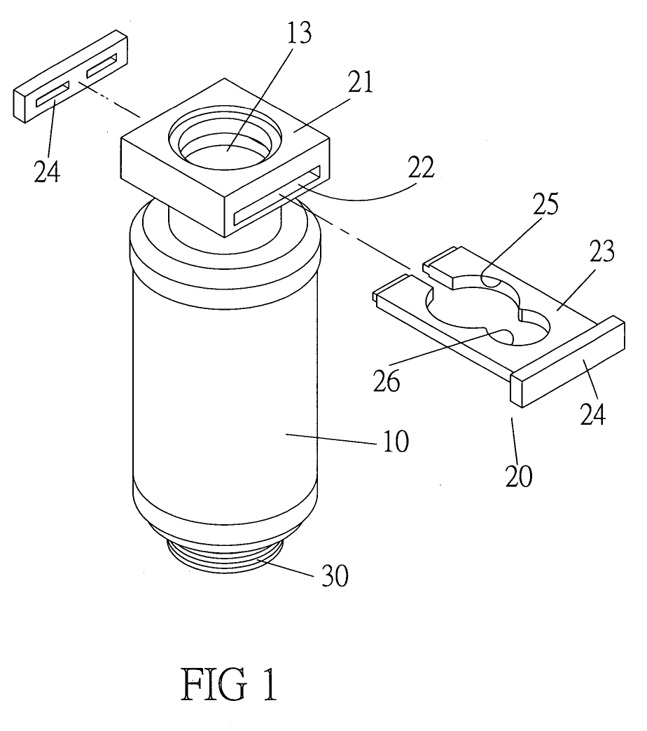

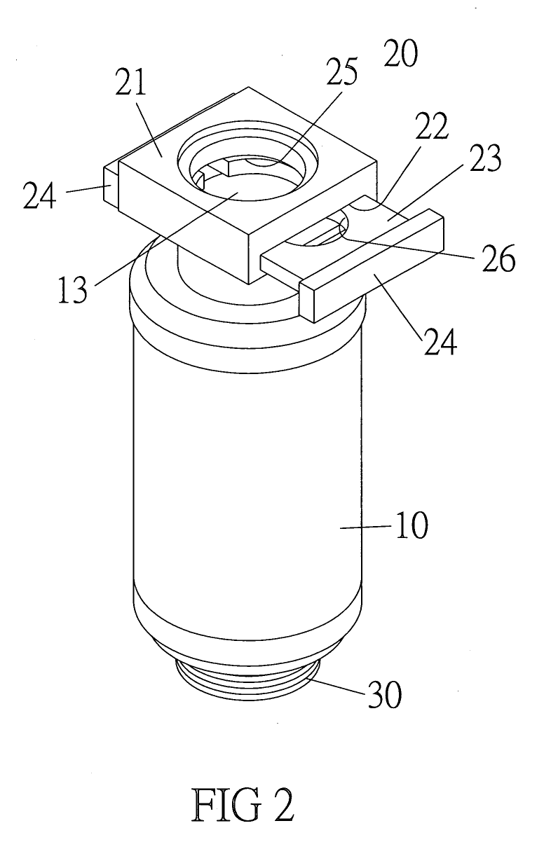

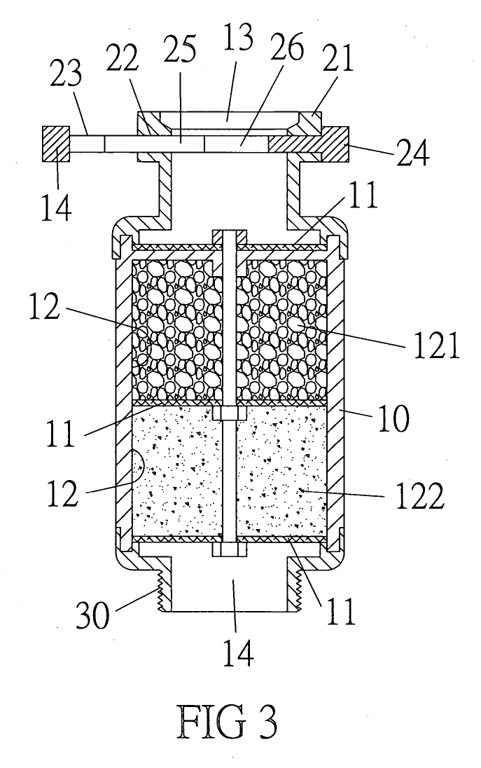

Referring to FIGS. 1 to 3, the water purifying device of the present invention comprises a tubular body 10 and a connection rod connects three filtering members 11 to define two spaces between the filtering members 11. Purifying material such as Porphyries 121 and active carbon particles 122 are received in the two spaces. The body 1 has an inlet 13 on a top and an outlet 14 at a bottom of the body 1. A first connection device is connected to the inlet 13 so as to introduce water into the body 1 and a second connection device is connected to the outlet 14 from which purified water flows out from the body 1.

The first connection device is a quick connection device 20 which includes a box 21 with a hole defined therethrough which is in communication with the inlet 13. A slot 22 is defined in a side of the box 21 and in communication with the hole. A clamp 23 is movably inserted into the slot 22 and includes a stop bar 24 and two clamp portions extend from the stop bar 24. The two clamp portion each include a first recess 25 and a second recess 26 so that when the two clamp portions are moved toward each other, two circular holes are defined by the first and second recesses 25, 26. A retaining member 24 includes two engaging holes and the two clamp portions are inserted with the two engaging holes in the retaining member 24 after the two clamp portions extend through the slot 22. The insertion 23 can be moved to let either of the two circular holes to share a common axis with the inlet 13. By this way, two connectors, hoses or faucets of different sizes can be clamped between the two clamp portions. The second connection device includes a threaded outer periphery 30 so as to be connected with a hose or a faucet having threaded inner periphery.

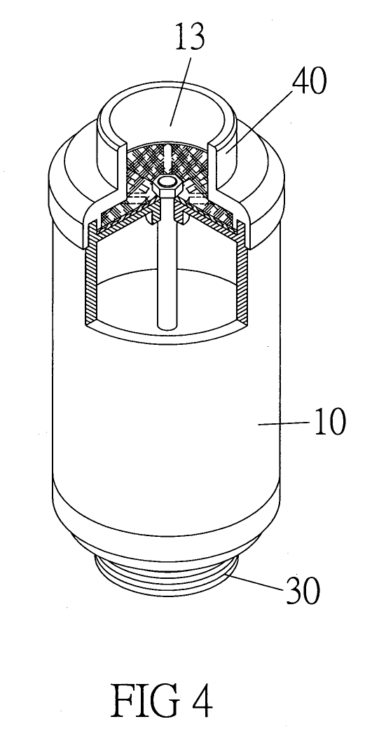

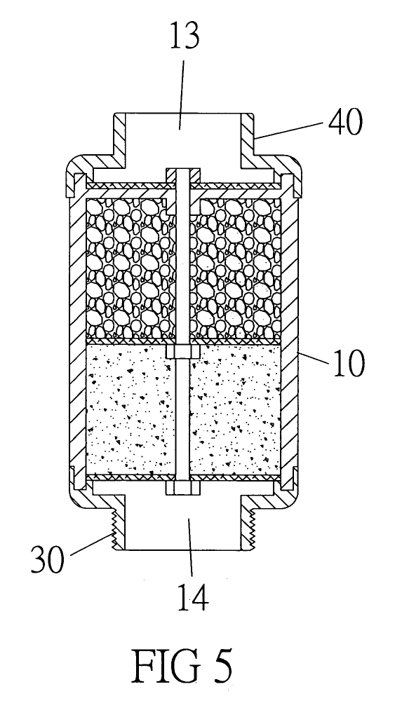

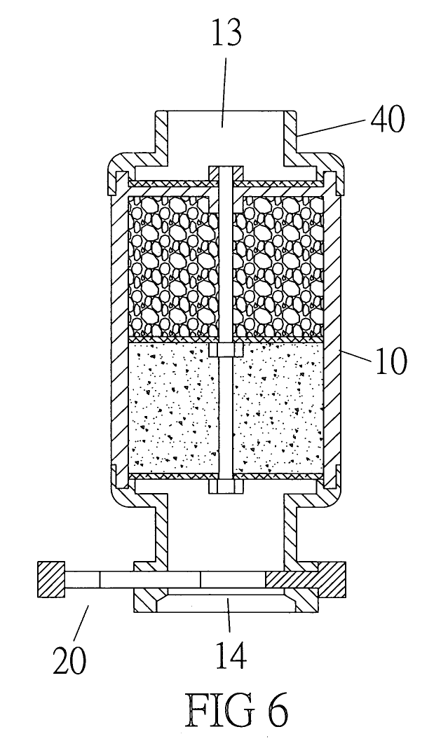

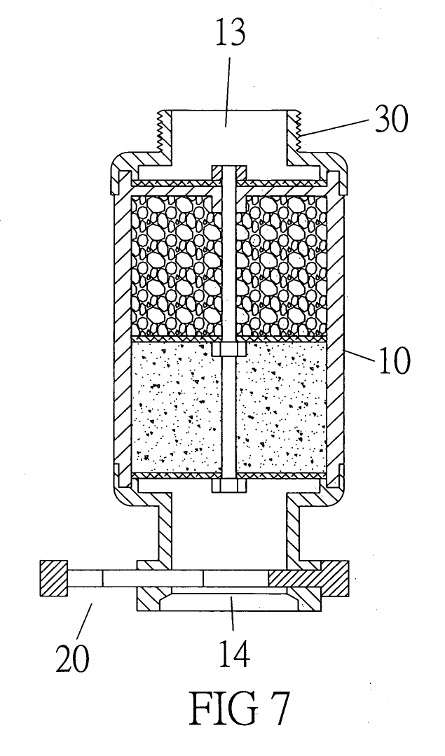

As shown in FIGS. 4 and 5, the first connection device can be a neck 40 with a smooth outer periphery. As shown in FIG. 6, the second connection device can be the same as the first connection device in FIGS. 1-3. As shown in FIG. 7, the first connection device can be the threaded outer periphery 30 and the second connection device can be the quick connection device 20 as in FIGS. 1-3.

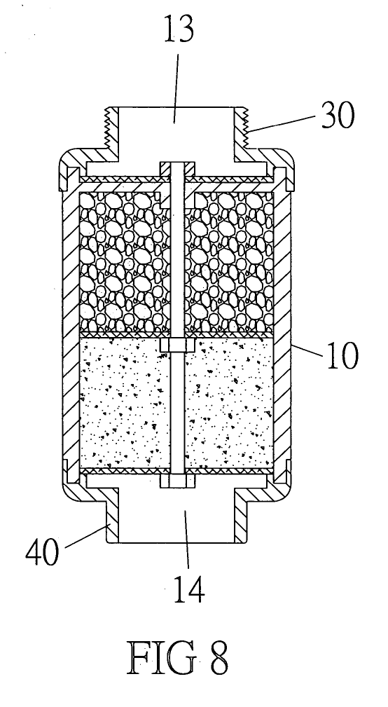

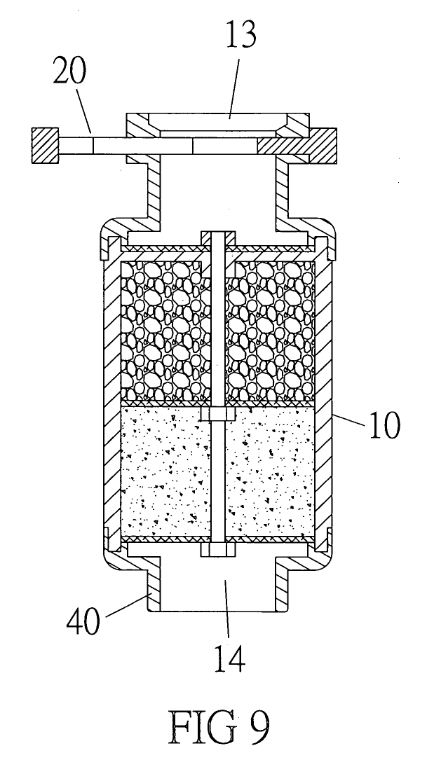

FIG. 8 shows that the first connection device can be the threaded outer periphery 30 and the second connection device can be the neck 40 with smooth outer periphery. FIG. 9 shows that first connection device can be the quick connection device 20 and the second connection device can be the neck 40 with smooth outer periphery.

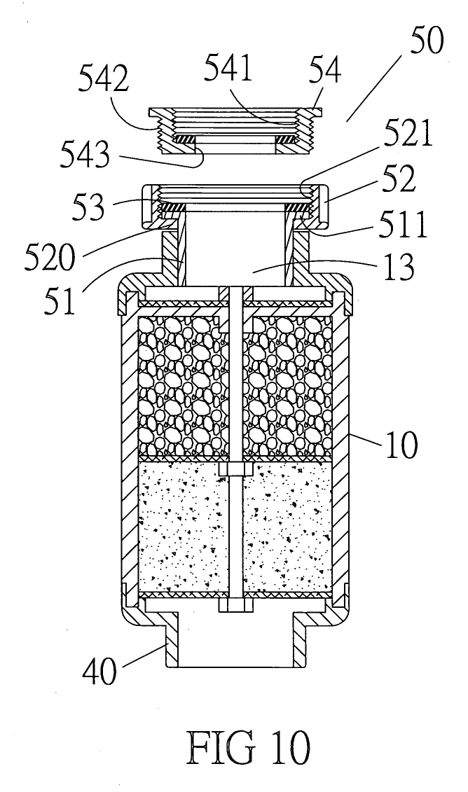

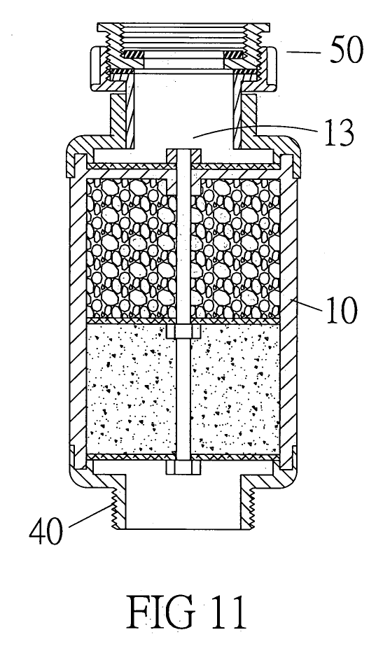

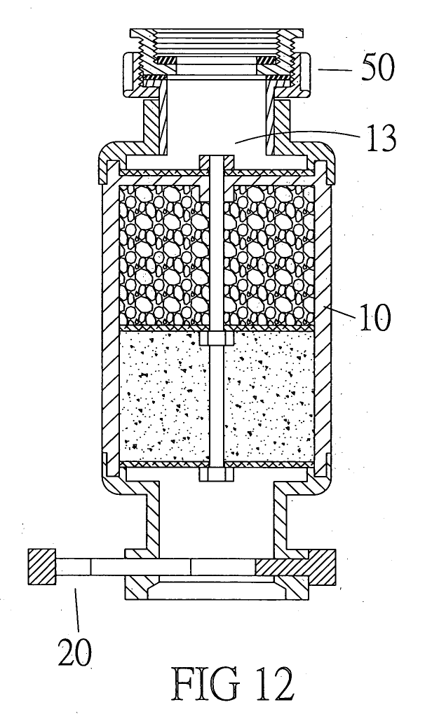

FIG. 10 to 12 show that the first connection device is a locking device 50 which includes a sleeve 51 with a flange 511 extending from an end thereof and the sleeve 51 is inserted in the inlet 13. A locking member 52 is rotatably mounted to the sleeve 51 and includes a first inward lip 520 which is stopped by the flange 511 so as to prevent the locking member 52 from disengaging from the sleeve 51. The locking member 52 includes a threaded inner periphery 521. A connection member 54 has a threaded inner periphery 541 and a threaded outer periphery 542 which is connected with the threaded inner periphery 521 of the locking member 52. The connection member 54 includes a second inward lip 543 which is rested on the flange 511 of the sleeve 51 and a seal is located on the second inward lip 543. An inner diameter of the sleeve 51 is larger than an inner diameter of the second inward lip 543 of the connection member 54. By this specific arrangement, the threaded inner periphery 521 of the locking member 52 and the threaded inner periphery 541 of the connection member 54, hoses or faucets of different sizes can be connected with the body 1.

The second connection device can be the neck 40 with smooth outer periphery, the threaded outer periphery 30 or the quick connection device 20.

While we have shown and described the embodiment in accordance with the present invention, it should be clear to those skilled in the art that further embodiments may be made without departing from the scope of the present invention.

What is claimed is:

1. A water purifying device comprising:
a body having an inlet and an outlet, purifying material being received in the body, a first connection device and a second connection device respectively connected to the inlet and the outlet.

2. The device as claimed in claim 1, wherein the first connection device includes a box with a hole defined therethrough which is in communication with the inlet/outlet, a slot is defined in a side of the box and communication with the hole of the box, a clamp is movably inserted into the slot and includes two clamp portions between, the two clamp portions each include a first recess so as to form a circular hole, a retaining member includes two engaging holes and the two clamp portions are inserted with the two engaging holes in the retaining member.

3. The device as claimed in claim 2, wherein the two clamp portion each include a second recess which is smaller than the first recess, the two second recesses define a second circular hole.

4. The device as claimed in claim 1, wherein the second connection device includes a threaded outer periphery.

5. The device as claimed in claim 1, wherein the first connection device is a neck with a smooth outer periphery.

6. The device as claimed in claim 1, wherein the first connection device includes a sleeve with a flange extending from an end thereof and the sleeve is inserted in the inlet/outlet, a locking member is rotatably mounted to the sleeve and includes a first inward lip which is stopped by the flange so as to prevent the locking member from disengaging from the sleeve, the locking member includes a threaded inner periphery, a connection member has a threaded inner periphery and a threaded outer periphery which is connected with the threaded inner periphery of the locking member, the connection member includes a second inward lip which is rested on the flange of the sleeve.

7. The device as claimed in claim 6, wherein an inner diameter of the sleeve is larger than an inner diameter of the second inward lip of the connection member.
